(19) United States
(12) Patent Application Publication
(10) Pub. No.: US 2018/0181153 A1
(43) Pub. Date: Jun. 28, 2018

(54) Equipment Operation Plan Generating Device and Equipment Operation Plan Generating Method

(71) Applicant: Hitachi, Ltd., Tokyo (JP)

(72) Inventors: Hirotaka TAKAHASHI, Tokyo (JP); Tsutomu KAWAMURA, Tokyo (JP); Tooru AKATSU, Tokyo (JP)

(21) Appl. No.: 15/854,392

(22) Filed: Dec. 26, 2017

(30) Foreign Application Priority Data
Dec. 27, 2016 (JP) 2016-252255

(51) Int. Cl. G05F 1/66; H02J 3/06; H02J 3/14; G05B 15/02; G06Q 50/06

(52) U.S. Cl. CPC G05F 1/66; H02J 3/06; G06Q 50/06; G05B 15/02; H02J 3/14

(57) ABSTRACT

Provided is an equipment operation plan generating device for generating an operation plan of a plurality of pieces of equipment for supplying energy from an energy supply network to a customer includes a group unit characteristic generating unit that divides the plurality of pieces of equipment into a plurality of groups, and generates group unit characteristic information indicating an energy consumption amount with respect to magnitude of output of a group unit from device unit characteristic information indicating an energy consumption amount with respect to magnitude of output of the equipment, a group unit plan generating unit that generates group unit operation plan information by regarding the plurality of pieces of equipment in the group as one equipment based on demand forecast information of the customer and the group unit characteristic information, and an equipment unit plan generating unit that generates the operation plan for each equipment based on the group unit operation plan information and the device unit characteristic information of the equipment included in the group.

### BACKGROUND OF THE INVENTION

### Field of the Invention

The present invention relates to an equipment operation plan generating device and an equipment operation plan generating method.

### Background Art

Recently, under a need to reduce running costs such as resilience and gas charges, a construction of a so-called “microgrid” in which power generation equipment and the like connected to a system to which a small-scale electric power system as one unit is applied is appropriately operated, has been activated. So far, the microgrid of a small-scale type such as a building itself was mainstream. In the future, since the running cost of the microgrid is further reduced, it is considered that the microgrid to deal with an electric power business market will appear. Since the unit of electric power dealt in the electric power business market is a megawatt (MW) level, it is assumed that there will be more power generation equipment in the microgrid compared with the related art. By increasing the number of pieces of the power generation equipment, a time required for generating an operation plan of these also increases compared with the related art. Meanwhile, in order for the microgrid to deal the electric power business market with the electric power, it is necessary to update the operation plan of the power generation equipment or the like one after another according to the change of situation. It is necessary to complete the generation of the operation plan of the power generation equipment by a bidding deadline or the like because there is a deadline for bidding for an electric power business market.

As one of the related art relating to an operation plan of a power generator or the like of the microgrid, there is a technology described in JP-A-2009-157624. In this document, a technology of an integrated maintenance and management system that can be connected to a plant equipment where a plurality of devices are installed and can formulate an optimum operation plan for high-efficiency operation of the device is described. Specifically, the integrated maintenance and management system has a data collection function for storing data collected from the plurality of devices, an operation plan formulation function for formulating an operation schedule in which an operation time zone within one operation cycle of the plurality of pieces of equipment is defined based on the data, and an operation time setting function for setting each operation start and end time based on the above operation schedule. In the operation plan formulation function, the system is to correct the operation schedule so as to evaluate an operation state of the device, to shorten an operation time of a device (low evaluation device) of which the operation state does not satisfy a predetermined standard, and to extend the operation time of a device (high evaluation equipment) of which the operation state satisfies a constant standard for the shortened operation time. By an application of this technology, since the whole operation efficiency of the power generation equipment or the like in the microgrid is improved, there is a merit that a running cost is reduced.

### SUMMARY OF THE INVENTION

Since a technology described in PTL 1 does not shorten a generation time of an operation plan, when the operation plan for a large microgrid in which a lot of pieces of power generation equipment are present is generated, there is a risk that it will not be in time by a bidding deadline of an electric power business market.

In order to solve the above-described problem, according to the present invention, there is provided an equipment operation plan generating device for generating an operation plan of a plurality of pieces of equipment for supplying energy from an energy supply network to a customer including a group unit characteristic generating unit that divides the plurality of pieces of equipment into a plurality of groups, and generates group unit characteristic information indicating energy consumption amount with respect to magnitude of output of a group unit from device unit characteristic information indicating an energy consumption amount with respect to magnitude of output of the equipment, a group unit plan generating unit that generates group unit operation plan information by regarding the plurality of pieces of equipment in the group as one equipment based on demand forecast information of the customer and the group unit characteristic information, and an equipment unit plan generating unit that generates the operation plan for each equipment based on the group unit operation plan information and the device unit characteristic information of the equipment included in the group.

According to present invention, it is possible to generate an operation plan of power generation equipment or the like present in a microgrid during a shorter time than that of the related art.

### BRIEF DESCRIPTION OF THE DRAWINGS

FIG. 1 is a diagram illustrating an overall configuration of a microgrid and an equipment operation plan generating device.

FIG. 2 is a diagram illustrating a data table of a group definition database.

FIGS. 3A and 3B are diagrams illustrating record information of a device database.

FIG. 4 is a flowchart of a processing time estimation function.

FIGS. 5A and 5B are explanatory diagrams of a group unit characteristic generation function.

FIG. 6 is a diagram illustrating a data table of a weather database.

FIG. 7 is a diagram illustrating a data table of a demand performance database.

FIG. 8 is a flowchart of a demand forecast function.

FIGS. 9A and 9B are explanatory diagrams of a group unit plan generation function.

FIG. 10 is a diagram illustrating a data table of a unit price database.

FIGS. 11A to 11C are explanatory diagrams of an equipment unit plan generation function.

### DETAILED DESCRIPTION OF THE INVENTION

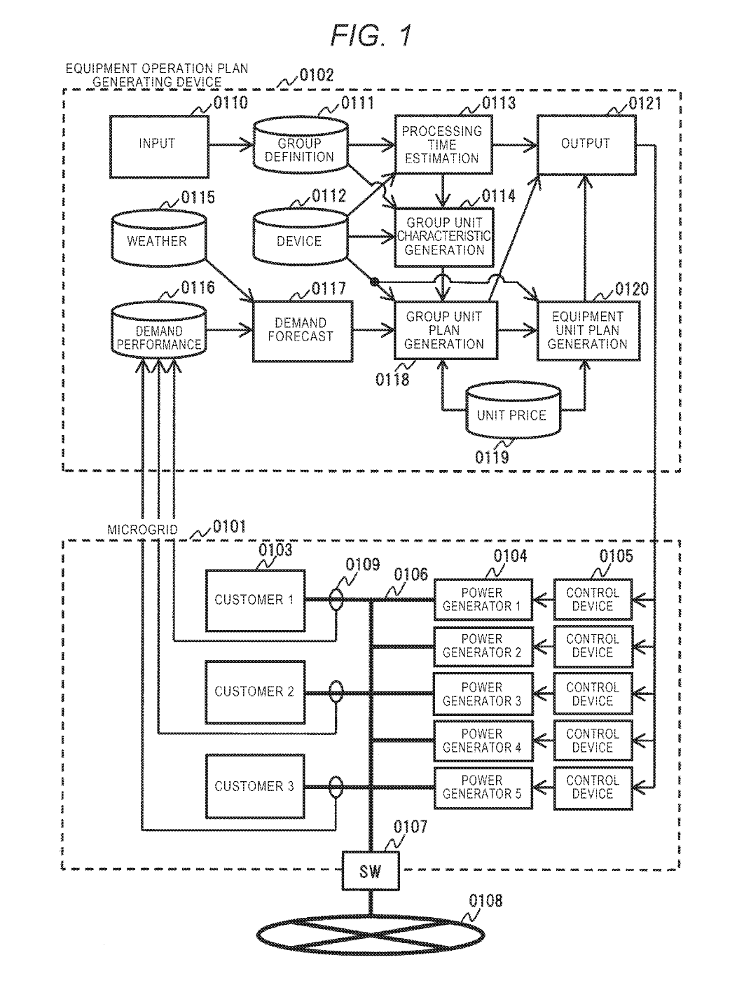

FIG. 1 is a diagram illustrating an overall configuration of a microgrid and an equipment operation plan generating device. 0101 is the microgrid, and 0102 is the equipment operation plan generating device.

First, the microgrid 0101 will be described.

The microgrid 0101 is configured with customers 0103, power generators 0104, control devices 0105 for controlling the power generators 0104, and distribution lines 0106 through which the customer 0103 and the power generator 0104 are connected to each other.

The customer 0103 receives a required electric power by the distribution line 0106. The electric power to be received is one or both of the electric power generated from the power generator 0104 which will be described below and the electric power to be received from an electric power system 0108 which will be described below. In this drawing, as an example, three customers are present in the microgrid 0101.

The power generator 0104 is a device for generating electricity by consuming fuel, and is operated according to a control instruction of the control device 0105. The electric power generated by the power generator 0104 is sent out to the distribution line 0106. As an example in this drawing, a case where five power generators are present in the microgrid 0101 is illustrated.

The microgrid 0101 is connected to the electric power system 0108 through a switch (SW) 0107. 0109 is a sensor that measures the electric power consumed by the customer 0103 and records the measured result to a demand performance database 0116.

Next, the equipment operation plan generating device 0102 will be described.

The equipment operation plan generating device 0102 may be a general computer, and has an input function such as a mouse and a keyboard, and an output function such as a monitor and a printer. In addition, the equipment operation plan generating device 0102 includes an input and output port for exchanging information with an external device.

0110 is an input function, and has a function for receiving an instruction instructed by an operator of the equipment operation plan generating device 0102. As the input function, there are the mouse, the keyboard, and the like. The operator divides the power generator 0104 into a plurality of groups, and inputs the divided plurality of groups through the input function 0110. The input result is recorded in a group definition database 0111. In addition, the operator inputs an upper limit value of a processing time required for an operation plan generating process through the input function 0110. The upper limit value of the input processing time is temporarily stored in a storage function (not shown).

0111 is a group definition database. A group to which each of the power generators 0104 belongs is recorded in the group definition database 0111.

0112 is a device database. Information of a rated output of the power generator 0104 and fuel consumption characteristics is stored in the device database.

0113 is a processing time estimation function. The processing time estimation function 0113 causes a time required for generating an operation plan of the power generator 0104 to be estimated from information on a method of grouping the power generators 0104 recorded in the group definition database 0111 and device characteristics recorded in the device database 0112. Information of the estimated processing time is output to an output function 0121, is sent to a group unit characteristic generation function 0114. Furthermore, the information of the estimated processing time is compared with an upper limit value of the processing time received by the operator through the input function 0110, if the estimated processing time is equal to or less than the upper limit value, it is “passed”, and if not, it is “failed”. The estimated result is output to the output function 0121 and the group unit characteristic generation function 0114.

0114 is the group unit characteristic generation function. The group unit characteristic generation function 0114 causes information such as the fuel consumption characteristics of each group to which the power generator 0104 is allocated to be generated from the information of the method of grouping the power generator 0104 recorded in the group definition database 0111 and the device characteristics of the power generator 0104 recorded in the device database 0112, and pass and fail information output by the processing time estimation function 0113. In a case where the pass and fail information sent from the processing time estimation function 0113 is “failed”, a process after this function is not performed. In this case, the operator sets another grouping method with respect to the power generator 0104, and inputs the set result to the input function 0110 again.

0115 is a weather database. Temperature information and humidity information required when the operation plan is generated by the equipment operation plan generating device 0102 generates are recorded in the weather database 0115. For the temperature information and the humidity information, a forecast value of the day following the past performance are recorded in time series. These types of information are obtained from external organizations.

0116 is the demand performance database. A result of an amount of the electric power consumption of the customer 0103 recorded by a sensor 0109 is recorded in the demand performance database 0116.

0117 is a demand forecast function. The demand forecast function 0117 causes forecast information of an electric power demand required for generating the operation plan from information of the weather database 0115 and information of a demand record 0116 to be generated. Demand forecast information to be generated is obtained by forecasting the total demand of the whole customer 0103 belonging to the microgrid 0101. The forecast information of the electric power demand is sent to the group unit plan generation function 0118.

0118 is a group unit plan generation function. The group unit plan generation function 0118 causes a group unit operation plan, to be generated, to which the power generator 0104 is allocated by using output information of the group unit characteristic generation function 0114, information of the device database 0112, the demand forecast information output by the demand forecast function 0117, and record information of a unit price database 0119 which will be described below. That is, a profile of a power generation amount with respect to a time of a group unit is generated.

0119 is the unit price database. Information on the unit price of fuel to be consumed in the power generator 0104 and a unit price of the electric power purchased from the electric power system 0108 are recorded in the unit price database 0119.

0120 is the equipment unit plan generation function. The equipment unit plan generation function 0120 causes the operation plan of each of the power generators 0104 to be generated from the operation plan of a group unit generated by the group unit plan generation function 0118.

0121 is the output function. The output function 0121 causes the operation plan information to be output according to an estimated result of the processing time output by the processing time estimation function 0113, the pass and fail information on whether or not the processing time is within the upper limit value, the operation plan information of the group unit output by the group unit plan generation function 0118, and the operation plan information of each power generator 0104 output by the equipment unit plan generation function 0120.

Hereinafter, each function belonging to the equipment operation plan generating device 0102 will be described in detail.

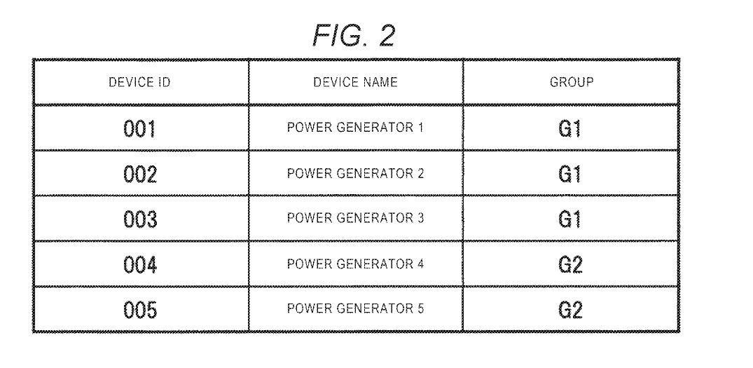

FIG. 2 is a diagram illustrating an example of a data table of the group definition database 0111. As components of the data table, there are a device ID, a device name, and a group. The device ID is an ID allocated in each of the power generators 0104. The device name is a name of each of the power generators 0104. The group is obtained by inputting by the operator through the input function 0110. Here, the power generators 1 to 3 are allocated to a G1 group, and the power generator 4 and 5 are allocated in a G2 group.

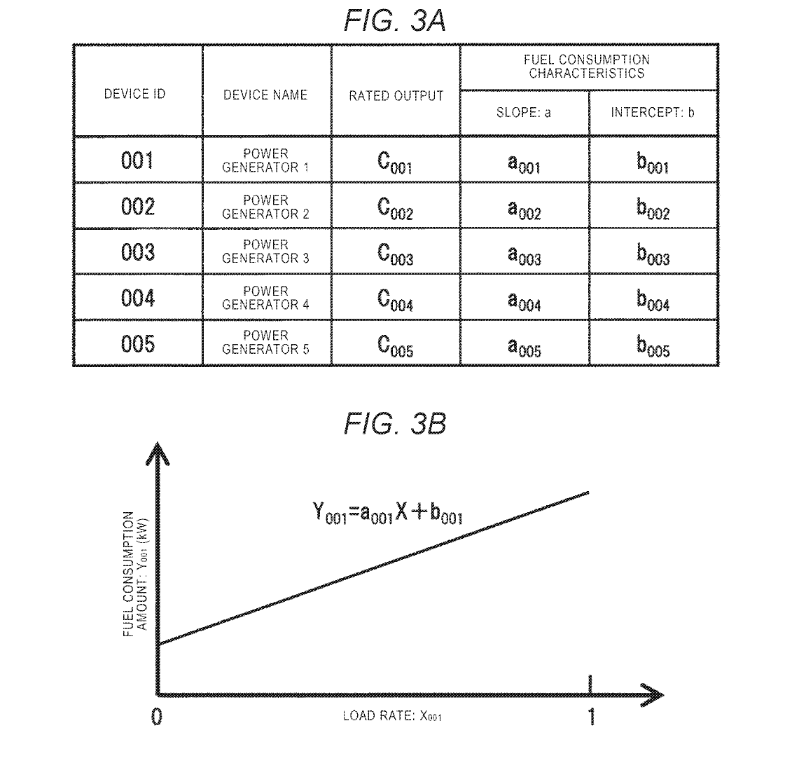

FIGS. 3A and 3B are diagrams illustrating record information of the device database 0112. FIG. 3A is a diagram illustrating an example of a data table. As components of the data table, there are the device ID, the device name, the rated output, and the fuel consumption characteristics. The device ID is an ID allocated in each of the power generators 0104. The device name is a name of each of the power generators 0104. The rated output is the rated output of each of the power generators 0104. The fuel consumption characteristics are characteristics of the fuel consumption amount with respect to a load rate (=ratio of power generation amount to rated output) of the power generator 0104. For the sake of simplicity of description, as illustrated in FIG. 3B, the fuel consumption amount is represented by a linear function with respect to the load rate, and its slope and intercept are recorded in the data table. For example, in FIG. 3B, the fuel consumption amount Y₀₀₁ of the power generator of which the ID of the power generator 0104 is 001 is represented by the linear function of a slope a₀₀₁ and an intercept b₀₀₁ with respect to the load rate X₀₀₁, and the slope a₀₀₁ and the intercept b₀₀₁ are recorded in the data table of FIG. 3A. In the following description, the fuel consumption characteristics of the power generator are described with the linear function, but it is not necessarily the linear function.

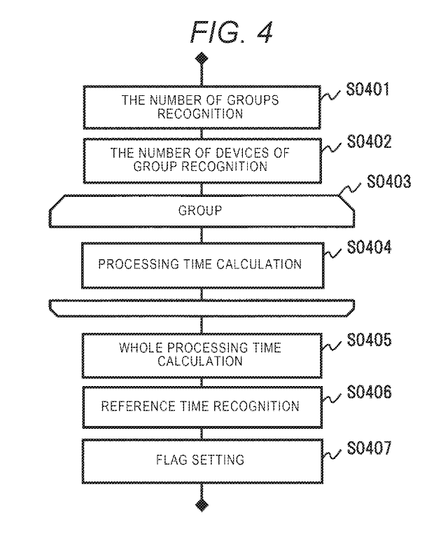

FIG. 4 is a flowchart of the processing time estimation function 0113.

In S0401, the number of the groups is recognized. Specifically, with reference to the group definition database 0111, the number of the groups recorded in a group field is checked. In this example, since the group is G1 and G2, the number of the groups is two.

In S0402, the number of devices of each group is checked. Similar to S0401, with reference to the group field of the group definition database 0111, the number of devices included in each group is checked. In this example, the number of devices belonging to the group G1 is three and the number of devices belonging to the group G2 is two.

In S0403, a loop of the group unit is performed.

In S0404, a generation time of the operation plan becomes longer according to an increase of the number of devices. A variety of calculation formulas are conceivable, but a case where the processing time exponentially increases according to the number of devices will be exemplified here. Here, it is assumed that a time required for generating the operation plan can be calculated by Equation 1.

T_{G}=P×Cⁿ Equation 1

However, T_{G} is a processing time for generating individual operation plan of the device of the group G, P and C are constants, and n is the number of devices belonging to the group G. For example, since the number of the power generators belonging to G1 is three in the generation of the operation plan of the power generator 0104 belonging to the group G1, a time of P×C³ is required.

In S0405, a time required for generating the operation plan of all power generators 0104 is calculated. Specifically, a time required for the operation plan generation of the group unit and a time required for the operation plan for each power generator in each group are summed up. A calculation formula is represented by Equation 2.

Tₜₒₜₐₗ=P×C^{G}+ΣT_{G} Equation 2

However, Tₜₒₜₐₗ is a time required for generating the operation plan of all power generators, P and C are constants, G is the number of the groups, and T_{G} is a time required for the operation plan generation of the power generator 0104 for each group.

In S0406, the upper limit value of the processing time that is input to the input function 0110 by the operator is recognized with reference to a temporary storage function (not shown).

In S0407, a calculated value of the processing time calculated in S0405 and the upper limit value recognized in S0406 are compared with each other. Then, if the calculated value is equal to or less than the upper limit value, a flag 1 is recorded in the temporary storage function (not shown), and if the calculated value is greater than the upper limit value, a flag 0 is recorded in the temporary storage function.

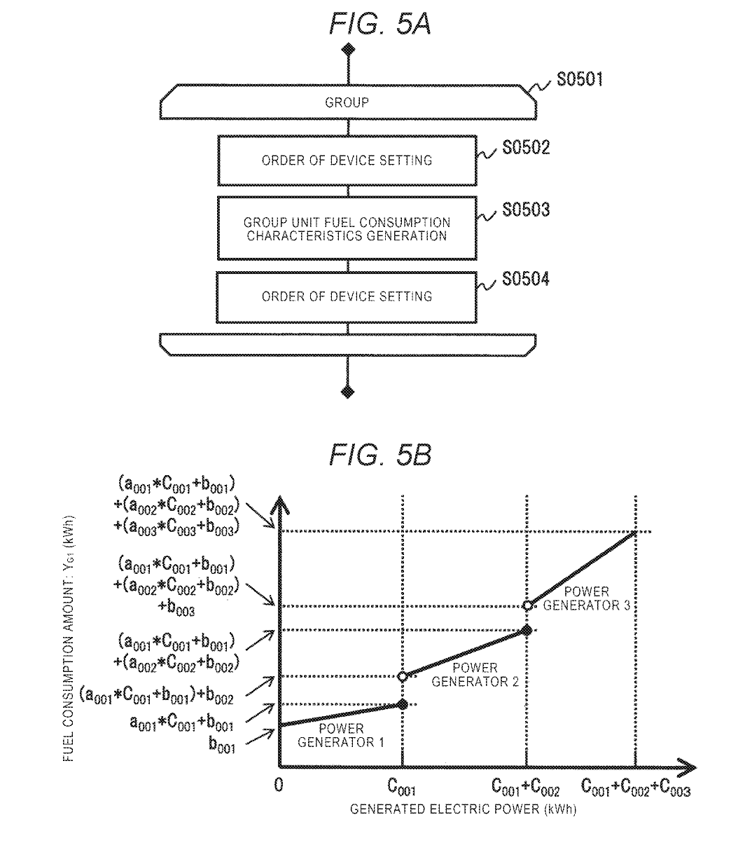

FIGS. 5A and 5B are explanatory diagrams of the group unit characteristic generation function 0114. FIG. 5A is a flowchart thereof.

In S0501, a loop of the group unit is performed. Specifically, since the number of the groups is two of G1 and G2, subsequent processes are performed twice.

In S0502, a ranking of equipment belonging to the group is processed. Specifically, it is the ranking in order of efficiency of the fuel consumption amount with respect to the power generation amount. That is, the slopes a of the fuel consumption characteristics recorded in the device database 0112 are to be in ascending order. In a case where values of the slopes a are the same, values of the intercepts b are ranked in the ascending order, and in a case where the values of the intercepts b are the same, values of rated outputs C are ranked in descending order.

In S0503, the fuel consumption characteristics of the group unit are generated. FIG. 3B is a diagram illustrating an example of the fuel consumption characteristics of the group unit. Here, it is assumed that a power generator 1, a power generator 2, and a power generator 3 belong to the group G1. Then, in S0502, it is assumed that they are ranked in order of the power generator 1, the power generator 2, and the power generator 3. First, for the power generator 1 of the first rank, the fuel consumption amount of a slope a₀₀₁ and an intercept b₀₀₁ is obtained. Next, for the power generator 2 of the second rank, when the electric power generated by the power generator 1 and the fuel consumption amount are added each other, the fuel consumption characteristics of a slope a₀₀₂ and an intercept b₀₀₂ are obtained. Similarly, for the power generator 3 of the third rank, when the electric power generated by the power generator 1 and the power generator 2 and the fuel consumption amount are added each other, the fuel consumption characteristics of a slope a₀₀₃ and an intercept b₀₀₃ are obtained. By this procedure, it is possible to generate the fuel consumption characteristics of the group unit with the fuel consumption amount less than that of necessary generated electric power. The process is performed for each group.

In S0504, the fuel consumption characteristics of the group unit generated in S0503 are output.

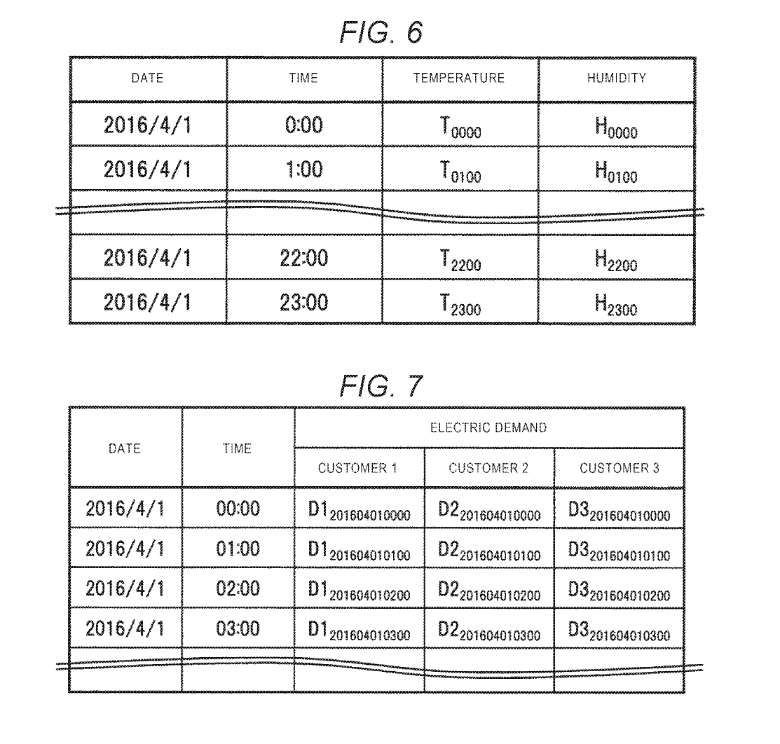

FIG. 6 is a diagram illustrating an example of a data table of the weather database 0115. A date, a time, temperature, and humidity are recorded in the data table. Past performance information and forecast data in a time zone in which the operation plan is generated from the past performance information are continuously recorded.

FIG. 7 is a diagram illustrating an example of a data table of the demand performance database 0116. Performance of the electric power demand for each date, time, and the customer is recorded in the data table. A performance value of the electric power demand is recorded by the sensor 0109.

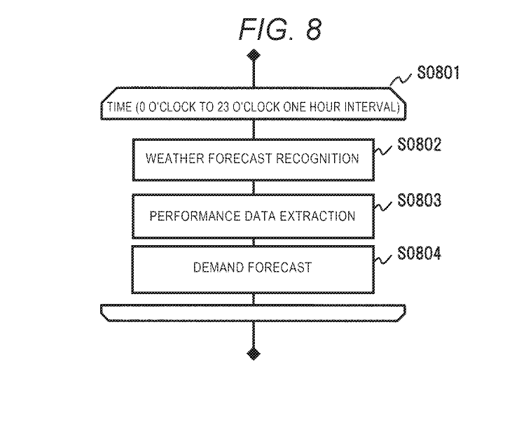

FIG. 8 is a diagram illustrating a flowchart of the demand forecast function 0117.

In S0801, a loop of a time is performed. For example, it loops for each hour from 0 o'clock.

In S0802, with reference to the weather database 0115, weather information of which a time matches a time of a loop process S0801 is obtained. The weather information to be obtained at this time is both past information and a target time zone information for generating the operation plan from the past information.

In S0803, with reference to the demand performance database 0116, information of which a time matches the time of the loop process S0801 is obtained with respect to electric power demand performance of the customer 0103.

In S0804, by using the information obtained in S0802 and S0803, the electric power demand of the entire microgrid 0101 at the time is forecast. For example, it is considered that a forecast method uses memory based reasoning (MBR).

By the above-described process, forecast information of the electric power demand for 24 hours is generated.

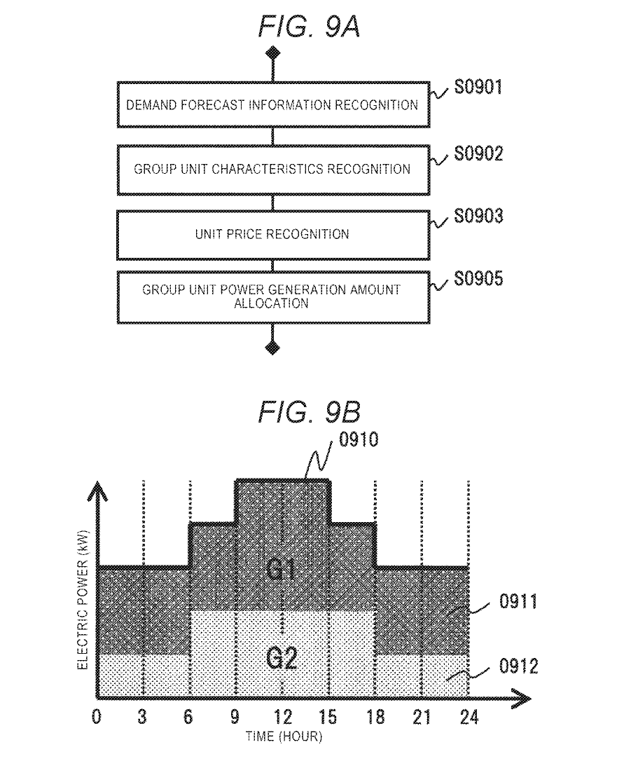

FIGS. 9A and 9B are explanatory diagrams of the group unit plan generation function 0118. FIG. 9A is a flowchart of this function.

In S0901, the content of electric power demand forecast information for 24 hours generated by the demand forecast function 0117 is recognized.

In S0902, the group unit characteristics are recognized. That is, the characteristics, which are generated by the group unit characteristic generation function 0114, of the fuel consumption amount with respect to the generated electric power of each group is recognized.

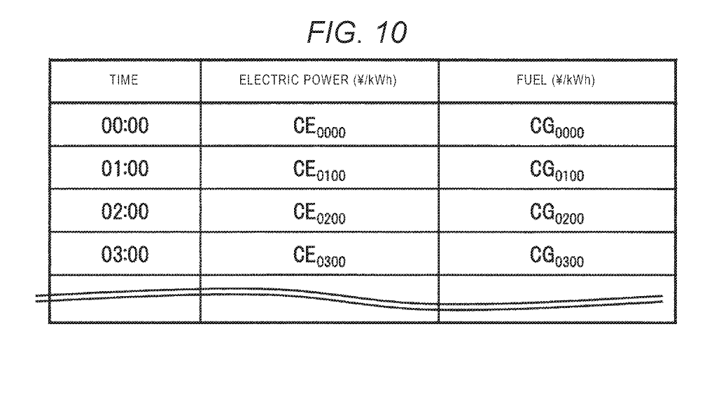

In S0903, a unit price is recognized. The unit price is obtained with reference to the unit price database 0119. Here, description is moved to FIG. 10.

FIG. 10 is a diagram illustrating an example of a data table of the unit price database. As the components of the data table, there are the time, the unit price of the electric power, and the unit price of the fuel. The unit price of the electric power is the unit price when purchasing the electric power from an electric power supplier, and the unit price of the fuel is the unit price when purchasing the fuel from a fuel supplier.

Returning to FIG. 9A. In S0904, with respect to the electric power demand of the microgrid 0101, the generated electric power for each time for each group is defined by optimization calculation from the fuel consumption characteristics and the unit price of the electric power and the fuel for each group to minimize the total cost of electricity and fuel bill. FIG. 9B is a diagram illustrating an example of a result after S0905 is performed. The power generation amount with respect to the electric power demand forecast value 0910 is allocated in the power generation amount 0911 of the group G1 and in the power generation amount 0912 of the group G2.

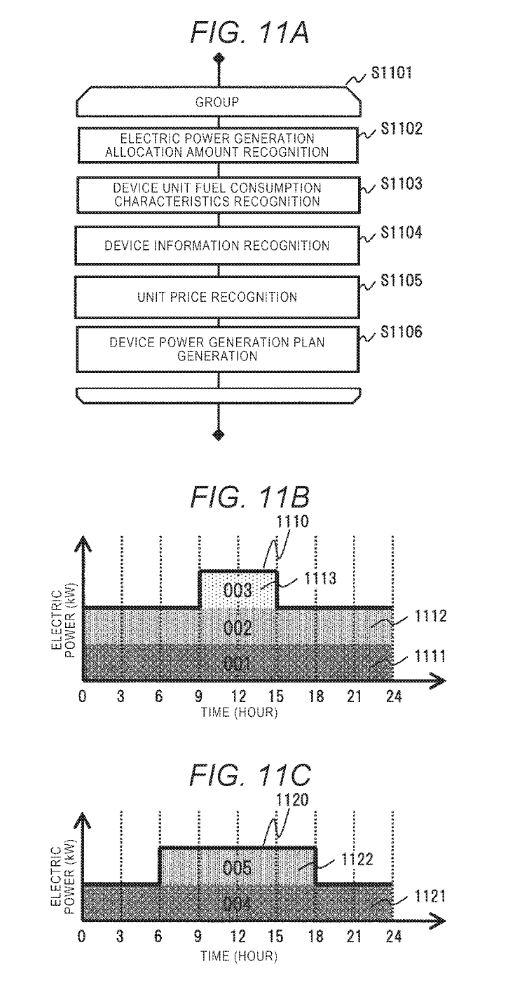

FIGS. 11A to 11C are explanatory diagrams of the equipment unit plan generation function. FIG. 11A is a flowchart thereof.

In S1101, a loop of the group is performed. Specifically, subsequent processes are performed for each of the group G1 and the group G2.

In S1102, an electric power generation allocation amount is recognized. The power generation allocation amount is the power generation amount by a time of each group illustrated in FIG. 9B.

In S1103, the fuel consumption characteristics of the device unit are recognized. The fuel consumption characteristics of the device unit are recognized based on information of the slope a and the intercept b with respect to the load rate with reference to the device database 0112.

In S1104, device information is recognized. Specifically, with reference to the device database 0112, the rated output of each of the power generators is recognized.

In S1105, a unit price is recognized. Specifically, with reference to the unit price database 0119, the unit prices of electricity price and fuel price are obtained.

In S1106, a power generation plan of the device is generated. Specifically, with respect to the power generation amount by a time allocated in the group allocated by the loop of S1101, the generated electric power for each time for each power generator is defined by optimization calculation from the fuel consumption characteristics of the power generator and the unit price of the electric power and the fuel belonging to the group so as to minimize the total cost of electricity and fuel bill. FIG. 11B is a diagram illustrating an example of a result obtained by generating the operation plan of the power generator generated in the group G1. With respect to the power generation amount 1110 allocated in the group G1, the operation plan of the power generator of an ID 001 is generated as 1111, the operation plan of the power generator of an ID 002 is generated as 1112, and the operation plan of the power generator of an ID 003 is generated as 1113. Similarly, FIG. 11C is a diagram illustrating an example of a result obtained by generating the operation plan of the power generator generated in the group G2. With respect to the power generation amount 1120 allocated in the group G2, the operation plan of the power generator of an ID 004 is generated as 1121 and the operation plan of the power generator of an ID 005 is generated as 1122.

Returning to FIG. 1. By the output function 0121, the estimated result of the processing time output by the processing time estimation function 0113, a determined result on whether or not the estimated result of the processing time is equal to or less than an upper limit time, a power generation amount distributed result (see FIG. 9B) of the group output by the group unit plan generation function 0118, and the operation plan (see FIGS. 11B and 11C) of the power generator output by the equipment unit plan generation function 0120 are output on a monitor or the like. Furthermore, the operation plan of the power generator is transmitted to the control device 0105 of the power generator 0104, and the power generator 0104 is controlled by the operation plan.

The present invention is not limited to the embodiments described above, but includes various modifications. For example, the above-described embodiments have been described in detail in order to explain the present invention in an easy-to-understand manner, and are not necessarily limited to those having all the configurations described. That is, for example, although the type of the device is limited to the power generator, it is not necessarily limited to the power generator, and equipment other than the power generator may be present. In addition, although the description is based on the assumption of the microgrid, the method described can also be applied to the case of generating the operation plan of a large power generator that supplies electric power to a general electric power system.

As an effect of the present invention, it is possible to divide a plurality of power generators into a plurality of groups, first the operation plan of the group unit is generated and then an individual operation plan of each power generator for each group is generated such that the total generation time of the operation plan can be shortened. Specifically, as represented in Equation 1, in a case where the time required for generating the operation plan exponentially increases with respect to the number of devices, a time required for generating the operation plan of the five power generators is represented by Equation 3.

processing time=P×C⁵ Equation 3

Here, for example, in a case of P=1 and C=10, the processing time is 10⁵. Next, a time required for the operation plan generation in a case using a method described in the embodiments of the present specification is represented by Equation 4.

processing time=P×C²+P×C³+P×C² Equation 4

The first term on the right side is a time required for allocating the power generation amount of the groups G1 and G2, the second term on the right side is a time required for generating the operation plan of the power generators (three units) belonging to the group G1, and the third term on the right side is a time required for generating the operation plan of the power generator (two units) belonging to the group G2. Here, under the same condition as the above, when P=1 and C=10, the time required for generating the operation plan is 10²+10³+10², that is, is 1,200. Accordingly, the required time is greatly reduced from 100,000 in Equation 3 to 1,200 in Equation 4. The accuracy of the operation plan is the same as that of the case of directly generating the generated electric power of each power generator without grouping.

What is claimed is:

1. An equipment operation plan generating device for generating an operation plan of a plurality of pieces of equipment for supplying energy from an energy supply network to a customer, the device comprising:
a group unit characteristic generating unit that divides the plurality of pieces of equipment into a plurality of groups and generates group unit characteristic information indicating an energy consumption amount with respect to magnitude of output of a group unit from device unit characteristic information indicating an energy consumption amount with respect to magnitude of output of the equipment;
a group unit plan generating unit that generates group unit operation plan information by regarding the plurality of pieces of equipment in the group as one equipment based on demand forecast information of the customer and the group unit characteristic information; and
an equipment unit plan generating unit that generates the operation plan for each equipment based on the group unit operation plan information and the device unit characteristic information of the equipment included in the group.

2. The equipment operation plan generating device according to claim 1,
wherein at least one of an electric power system and a heat supply system are included in the energy supply network.

3. The equipment operation plan generating device according to claim 1,
wherein the equipment includes at least one of a power generator, a refrigerator, a water heater, and a boiler.

4. The equipment operation plan generating device according to claim 1,
wherein a cost required for operating the equipment includes a fuel cost purchased to operate the equipment or a fuel cost for purchasing energy supplied from the energy supply network.

5. The equipment operation plan generating device according to claim 1, further comprising:
a processing time estimating unit that estimates a time required for generating the operation plan of the equipment based on definition information relating to grouping of the equipment and the device unit characteristic information.

6. The equipment operation plan generating device according to claim 1, further comprising:
a demand forecasting unit that generates the demand forecast information based on weather information including at least one of temperature information and humidity information and demand performance information.

7. The equipment operation plan generating device according to claim 1,
wherein data relating to the equipment includes a device ID, a device name, a rated output, and the device unit characteristic information.

8. The equipment operation plan generating device according to claim 1,
wherein the device unit characteristic information includes characteristic information of a fuel consumption amount for a load rate indicating a ratio of the power generation amount with respect to a rated output of the power generator.

9. The equipment operation plan generating device according to claim 1,
wherein the group unit plan generating unit ranks the plurality of pieces of equipment belonging to the group in order of increasing efficiency of a fuel consumption amount with respect to a power generation amount.

10. An equipment operation plan generating method for generating an operation plan of a plurality of pieces of equipment for supplying energy from an energy supply network to a customer, the method comprising:
dividing the plurality of pieces of equipment into a plurality of groups and generating group unit characteristic information indicating an energy consumption amount with respect to magnitude of output of a group unit from device unit characteristic information indicating an energy consumption amount with respect to magnitude of output of the equipment;
generating group unit operation plan information by regarding the plurality of pieces of equipment in the group as one equipment based on demand forecast information of the customer and the group unit characteristic information; and
generating the operation plan for each equipment based on the group unit operation plan information and the device unit characteristic information of the equipment included in the group.
